(19) United States
(12) Patent Application Publication
(10) Pub. No.: US 2011/0158051 A1
(43) Pub. Date: Jun. 30, 2011

(54) PRESENTATION APPARATUS AND CONTROL METHOD THEREOF

(75) Inventor: Yi-Ping HSU, Jhonghe City (TW)

(73) Assignees: SILITEK ELECTRONIC (GUANGZHOU) CO., LTD., Guangzhou (CN); LITE-ON TECHNOLOGY CORPORATION, Taipei City (TW)

(21) Appl. No.: 12/753,947

(22) Filed: Apr. 5, 2010

(30) Foreign Application Priority Data
Dec. 25, 2009 (CN) 200910260243.8

(51) Int. Cl. G04F 10/00; G04B 47/00

(52) U.S. Cl. 368/10; 368/109

(57) ABSTRACT

A presentation apparatus has an operating main body. The operating main body further includes a LED module and a control unit. The LED module is disposed on a surface of the operating main body. The control unit is electrically connected to the LED module, and controls the LED module to display a timing message in response to a timing signal, and then controls the LED module to display a warning message in response to a triggering signal when the timing signal exists, thereby achieving the objective that the presentation apparatus have multiple functions with low manufacturing cost.

### BACKGROUND OF THE INVENTION

1. Field of the Invention

The present invention relates to a presentation apparatus and a control method thereof; in particular, the present invention relates to a presentation apparatus and a control method thereof for implementing timing and warning features by using visual effects.

2. Description of Related Art

It is currently very common to use computers for performance of presentation at a conferencing occasion. In order to prevent inconvenience in personally operating controls over mouse or keyboard for functions such as page turning and the like of the presentation materials during the presentation process, many wireless presentation devices have been developed which allow connections to the computer in a wireless fashion for further remotely controlling the computer over actions like page turning or mouse clicking on the presentation materials during the presentation process. This facilitates the user to conveniently and comfortably conduct the presentation operation, enabling more streamlined integral presentation workflow.

Along with the increased consideration in terms of handiness, in order to allow the user to be able to clearly and specifically indicate the contents of the presentation materials shown on a projection screen, currently available presentation devices are further combined with the design of a laser pen. In this way, upon presentations, the user can not only easily switch to the specific page or computer screen of the presentation materials intended to be introduced or described, but point out the contents of the presentation materials on the projection screen by means of the laser light spot emitted from the laser pen through the operation on the same presentation device thereby allowing the audience to clearly appreciate the specific location of the contents presently illustrated.

In addition, the user working on presentation actions may be too busy to be able to frequently pay attention to the representation time left showing by a timing device like a clock or a watch, or even unable to notice it. Therefore, in an occasion of presentation, the duration of the entire presentation usually stands for the factor that is most unlikely to be precisely controlled. To this, newer presentation devices are further configured with a timer, a Liquid Crystal Display (LCD) and a vibrator, thereby allowing the user to schedule a preset duration of time through the display on the LED and facilitating appreciation of time countdown. Besides, as the end of the preset duration approaches, the device can prompt the user by means of vibration effects provided by the vibrator. Thus the actions of timing and warning can be effectively done.

From the evolution process of the presentation device set forth hereinbefore, it can be seen that in order to offer a presentation operating environment with higher convenience and more features to the user, add-on functions are incessantly introduced into the development of presentation device designs. However, this many undesirably cause significant increase in design costs of the presentation device, and when such an increase in the product cost becomes practically unacceptable, it is believed that the willingness for purchase and use of the presentation device will be negatively affected which alters the initial objective for design of the presentation device originally supposed to be comprehensively utilized. Thus, based on the requirements for considerations in terms of both functionality and cost, further improvements on development design thereof are consequently needed.

### SUMMARY OF THE INVENTION

In view of the aforementioned contexts, the issues to which the present invention is directed are to design a presentation apparatus offering both timing and warning features without significantly giving rise to the cost, and the provided timing and warning feature can effectively prompt the user without affecting the audience.

One embodiment of the present invention provides a presentation apparatus, comprising an operating main body and a receiver. The operating main body further includes: a Light Emitting Diode (LED) module, a control unit and an operating module. The LED module includes a plurality of LEDs and is installed on a surface of the operating main body, and the control unit is electrically connected to the LED module. Therefore, the control unit controls the LED module according to a timing signal to display a timing message, and in the existence of the timing signal, controls the LED module to display a warning message based on a triggering signal. The operating module is electrically connected to the control unit for setting an overall timing duration, and operates to generate at least one function signal of the presentation apparatus. On the other hand, the receiver is wirelessly connected to the operating main body so as to receive the function signal and then forward the received function signal to an application system.

Another embodiment of the present invention provides a control method to a presentation apparatus, comprising the steps of: firstly, setting an overall timing duration, and counting an overall elapsed time up to the overall timing duration to generate a timing signal. Then, inquiring a correspondence table based on the timing signal to control an LED module to display a timing message in response to an inquired control parameter. When counting the overall elapsed time remains a default time, generating a triggering signal. Further, inquiring the correspondence table based on the timing signal and the triggering signal, and controlling the LED module to display a warning message in response to another inquired control parameter.

As such, the effects which the present invention can provide lie in that the presentation apparatus according to the present invention itself no long needs to add additional expensive components and modules, but can use well-designed visual effects of light sources to effectively prompt and notify the user, which allows the user to be aware of and manage the presentation time. In this way, the presentation apparatus according to the present invention may offer advantages in both functionality and reduced price.

To further understand the characteristics and technical contents of the present invention, references are hereunder made to the following detailed descriptions and appended drawings of the present invention; however, the appended drawings are simply illustrative and referential, rather than for limiting the scope of the present invention thereto.

### BRIEF DESCRIPTION OF THE DRAWINGS

FIG. 1 is a block diagram for an embodiment of the presentation apparatus according to the present invention;

FIG. 2 is a perspective view diagram for an embodiment of the presentation apparatus according to the present invention;

FIG. 3 is a diagram for a first embodiment of the LED module according to the present invention;

FIG. 4 is a diagram for a second embodiment of the LED module according to the present invention; and

FIG. 5 is a flowchart for an embodiment of the control method to the presentation apparatus according to the present invention.

### DETAILED DESCRIPTION OF THE PREFERRED EMBODIMENTS

The presentation apparatus according to the present invention can be applied in conjunction with an application system (e.g. a computer) thereby allowing a user, upon using the application system and a projector to perform a presentation demonstration, to be able to remotely manipulate the operations of the computer and actions such as page turning of the presentation materials played on the computer through operations on the presentation apparatus. The present invention allows to effectively provide features of timing and warning under a design condition of not greatly increasing the product cost, thereby enabling clear appreciation and control of presentation time by the user during the process of presentation and accordingly enhancing convenience regarding the application thereof. More importantly, in implementing the timing and warning features, one single LED module is designed to allow the user to realize and adjust the entire presentation duration of time by means of visual effects created by the light illumination variations of the light source directly.

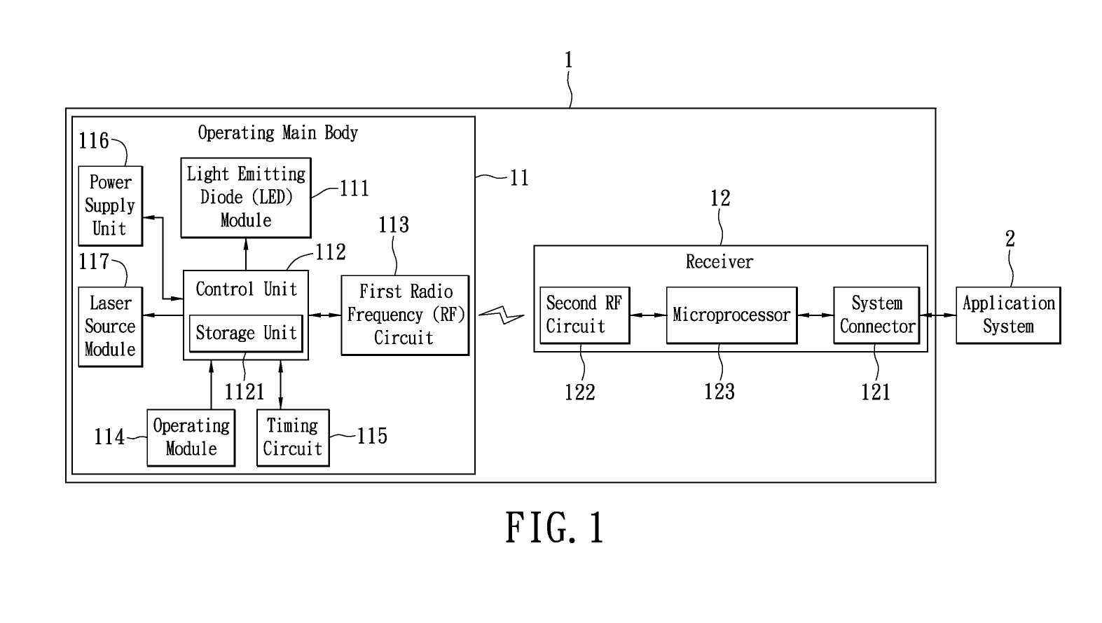

Refer initially to FIG. 1, wherein a block diagram for an embodiment of the presentation apparatus according to the present invention is shown. As depicted, the present embodiment provides a presentation apparatus 1 comprising: an operating main body 11 and a receiver 12. Herein the operating main body 11 is wirelessly connected to the receiver 12, and the receiver 12 is used to connect to an application system 2 thereby generating an electric connection therewith. The operating main body 11 in circuitry architecture further includes: a Light Emitting Diode (LED) module 111, a control unit 112, a first radio frequency (RF) circuit 113, an operating module 114, a timing circuit 115 and a power supply unit 116. Meanwhile, the receiver 12 in circuitry architecture further includes: a system connector 121, a second RF circuit 122 and a microprocessor 123.

Initially, for the operating main body 11, the LED module includes a plurality of LEDs (not shown), and is configured on a surface of the operating main body 11, which is usually placed on the surface that easier to be seen by the user during operations of the presentation apparatus 1.

The control unit 112 is electrically connected to the LED module 111 so as to control the LED module 111 to display a timing message in accordance with a timing signal, and in the existence of the timing signal, further control the LED module 111 to display a warning message based on a triggering signal. In other word, the control unit 112 controls all of the LEDs in the LED module 111 according to variations in the timing signal as well as the triggering signal to present various patterns associated with light source of different colors, illumination/blackout and blinking frequency etc., thereby displaying different timing and warning messages. For example, all of the LEDs in the LED module 111 can display an ON/OFF pattern in a way of a lighted marquee or lighting in different spacing/interval or else. No limits exist regarding such an arrangement in the present invention, and all possible variation effects in the light source enabling timing differentiation and warning prompt can be used as the practical pattern for controlling the display of timing and warning messages by the LED module 111 in accordance with the present invention.

For more concrete design, the control unit 112 further includes a storage unit 1121 for storing a correspondence table. The correspondence table records plural sets of control parameters to respectively indicate a display pattern displayed by the LEDs in the LED module 111 under different timing signals and triggering signals, thereby creating a database-like design style. As such, in operations, the control unit 112 inquires the correspondence table upon reception of the timing signal and the triggering signal, and then controls the LEDs in the module 111 based on the inquired control parameters thereby illuminating in different display patterns.

The first RF circuit 113 is used to wirelessly connect to the receiver 12 for wireless signal transmissions. The operating module 114 includes for example a plurality of function keys and is electrically connected to the control unit 112 for user's operations to set an overall timing duration and generate at least one function signal of the presentation apparatus 1 (e.g., mouse cursor signal for operating the application system 2, page turning signal for controlling the presentation materials played on the application system 2 and so forth). For further illustration, the control unit 112 switches between a setup mode and an operation mode based on one of the function keys in the operating module 114 (depending on the actual design). When the control unit 112 switches to operate in the setup mode, the operating module 114 can be used to set the overall timing duration; while the control unit 112 switches to operate in the operation mode, the operating module 114 is able to generate a function signal of the presentation apparatus 1.

It should be noticed that, in order to lessen the number of keys in the operating module 114 for cost reduction, certain keys in the operating module 114 according to the present invention are designed to be combined key groups thereby allowing the same key to generate different keystroke function when the control unit 112 switches to operate in different mode. For example, in the present embodiment, the keys used to set the time increase/decrease function for the overall timing duration and to operate for generating the forward/backward page turning function of the presentation apparatus 1 are designed as the combined key group. Furthermore, in addition to the design configuration with keys, it is also possible to alternatively use knobs to meet the actual design requirements.

The timing circuit 115 is used to count (commonly in a way of countdown) an overall elapsed time till the overall timing duration after finishing the setup of the overall timing duration through the operating module 114 by the user thereby generating the timing signal to the control unit 112, and to generate the triggering signal to further notify the control unit 112 upon at least a default time remained as counting to the overall timing duration. Herein the start of counting in the counting circuit 115 may be based on, for example, the moment when the user presses down another function key in the operating module 114 (depending on the actual design) and an enable signal is thus generated to the control unit 112, thereby allowing the control unit 112 to control the timing circuit 115 to start counting to the overall timing duration based on such an enable signal.

Furthermore, since in the present embodiment an LED display module 111 is commonly used to display the timing message and the warning message, for the design of the timing circuit 115, the triggering signal thus generated may be designed to maintain for a period of warning time. That is, upon reaching the default time as the timing circuit 115 counts to the overall timing duration, during the warning time, the triggering signal will be continuously generated and transmitted to the control unit 112; whereas after exceeding such a warning time, the generation of the triggering signal will be stopped, allowing the control unit 112 to control over the LED display module 111 in showing the timing message.

In addition, it should be noted as well that the time point of the aforementioned default time may be configured as the factory default according to general customs before product shipment. For example, it may be simply designed as two default time points, respectively three minutes before the end of countdown and one minute left before the end of countdown. When the remained time as counting to the overall timing duration by the counting circuit 115 reaches such two default time points, a corresponding triggering signal can be respectively generated to notify the control unit 112 to control the LED module 111 for displaying the warning message in different patterns.

For example, upon three minutes remained before the end of overall timing duration, the control unit 112 further receives a first triggering signal generated by the counting circuit 115 so as to inquire the correspondence table based on the timing signal and the first triggering signal, thereby further controlling all of the LEDs in the LED module 111 in accordance with the inquired control parameter to illuminate in a display pattern of simultaneously blinking 3 times; while at one minute left before the end of overall timing duration, the control unit 112 further receives a second triggering signal generated by the counting circuit 115, and after inquiry to the correspondence table based on the timing signal and the second triggering signal, it controls all of the LEDs in the LED module 111 in accordance with the inquired control parameter to illuminate in a display pattern of simultaneously blinking and maintaining up to the period of the warning time. In other words, the display patterns presented by the LEDs at the above-mentioned two default time points are also determined by the control parameter in the correspondence table. Of course, in a practical design, the control parameter in the correspondence table may indicate in default a blinking frequency different from the aforementioned frequency, or may be even designed as a display pattern by showing the light source of different colors, turning light on or off and the like. Consequently, upon reaching the default time as counting down the overall timing duration, the control unit 112 can control the LED module 111 to display the warning message according to the inquired control parameter.

It is required to further notice that, for those skilled ones in the art, it can be appreciated that before reaching the default time as counting to the overall timing duration, the output status of the triggering signal in the timing circuit 115 is to generate a Null triggering signal. Hence, the control unit 112 at this moment inquires the correspondence table in response to the timing signal and the Null triggering signal for controlling the LED module 111 to display the timing message in accordance with the inquired control parameter.

Additionally, for the purpose of brevity, the timing circuit 115 in the present embodiment is designed as a pattern being externally connected to the control unit 112; however, in practice, it may be also directly built inside the control unit 112 so as to further reduce circuit space and design cost.

The power supply unit 116 (e.g., alkaline battery) is used to supply the power required for operations of the operating main body 11. In addition to the displays of the timing message and the warning message, the LED module 111 of the present embodiment can further offer a feature of low power prompt with regards to the power supply unit 116. In design, the control unit 112 is electrically connected to the power supply unit 116 for detecting the voltage of the power supply unit 116, and upon detection of the voltage of the power supply unit 116 being lower than a voltage threshold, it then controls the LED module 111 to display a low power message, such as in a simpler design by the illumination of a red LED in the LED module 111.

Finally, the operating main body 11 of the present embodiment is further configured with a laser source module 117 which is electrically connected to the control unit 112, and generates a laser beam by receiving the control of the control unit 112 when the user presses down a laser indictor key (not shown) in the operating module 114, thereby allowing the user to specifically indicate the contents of the presentation materials projected on the projection screen.

Next, the receiver 12 is used to transfer the function signal generated by the operating main body 11 to the application system 2. Herein the system connector 121 is electrically connected to the application system 2 and in a practical design it is possible to adopt the specifications of commonly used Universal Serial Bus (USB) to form a so-called USB dongle to facilitate connections with the application system 2. Besides, the second RF circuit 122 is used to establish the wireless connection with the first RF circuit 113 in the operating main body 11. In design, the first RF circuit 113 and the second RF circuit 122 may be, e.g. wireless RF modules of 2.4 GHz for wireless communication. The microprocessor 123 is electrically connected between the system connector 121 and the second RF circuit 122 for transforming the function signal generated by the operating main body 11 and sending the transformed function signal to the application system 2.

Through descriptions about the aforementioned architecture, it can be understood that it is possible to allow the user to conveniently use the presentation apparatus 1 and to effectively control the presentation time when using in conjunction with the application system 2, thereby facilitating more streamlined presentation processes.

Additionally, the aforementioned embodiment illustrates the presentation apparatus 1 in a state of use. After the user finishes the presentation operation, in order to provide more handy accommodation of the presentation apparatus 1 with less occupation in space, there further installs an accommodating space (not shown) in the operating main body 11 thereby enabling the placement of the receiver 12 in the accommodating space when the user unplugs the receiver 12 from the application system 2.

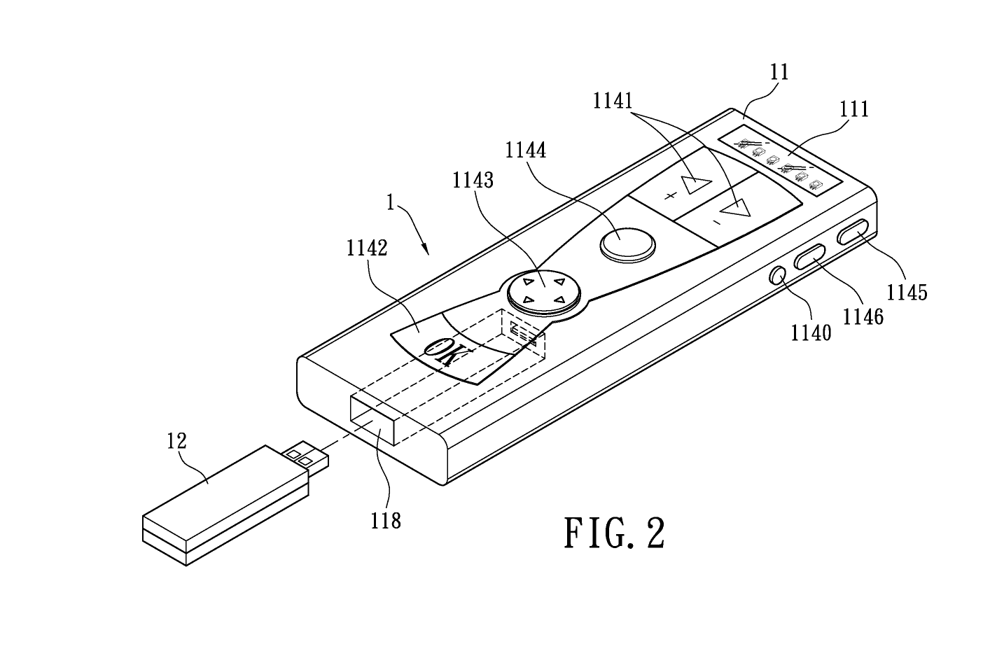

To better understand the implementation of the presentation apparatus 1 according to the present invention, reference is now made to FIG. 2 in accordance with FIG. 1, wherein a perspective view diagram for an embodiment of the presentation apparatus according to the present invention is shown. As illustrated in FIG. 2, the presentation apparatus 1 according to the present embodiment can be clearly seen that the LED module 111 and an accommodating space 118 for accommodation of the receiver 12 as per the external appearance view of the operating main body 11. Moreover, the operating module 114 internally is also configured with a timing mode key 1140, a combined key group 1141, a confirmation key 1142, a cursor control key 1143, a laser indicator key 1144, a cancel key 1145 and a black screen control key 1146.

Herein the timing mode key 1140 is designed to switch the key function of the combined key group 1141. In case the control unit 112 switches to the general operation mode, the combined key group 1141 allows the user to operate to generate the function signal for forward/backward page turning; while a switch signal is generated by the user through pressing down the timing mode key 1140 for a longer duration, thereby allowing the control unit 112 to switch to the setup mode, and the combined key group 1141 alternatively provides the function for increasing/decreasing the overall timing duration setting.

After setting up the overall timing duration, the user can use the confirmation key 1142 to affirm and store the settings and then exit the setup mode. Afterward, the user may generate the enable signal by pressing down the laser indictor key 1144 or pressing down briefly the timing mode key 1140, allowing the control unit 112 to control the timing circuit 115 to start counting to the overall timing duration. Herein, to differentiate the above-mentioned long and short pressings over the timing mode key 1140, it is possibly determined by that, for example, whether a time value (e.g., 3 seconds) has elapsed as pressing and holding the timing mode key 1140; certainly, such a time value can be modified depending on actual design demands.

Taking the present embodiment as an example, the LED module 111 in the present embodiment is exemplarily configured with 6 LEDs, and when the user switches the control unit 112 to enter into the setup mode, the LED module 111 is used to correspondingly display the elapsed duration of time for the overall timing duration; that is, with each LED in the LED module 111 indicating an accumulated time, all of the LEDs may conjunctively represent the overall timing duration. For example, suppose each LED indicates in default an accumulated time of five minutes, when the user operates the combined key group 1141 to set the overall timing duration, for each increment of five minutes, one more LED in the LED module 111 will light up, so on and so forth; in case all six LEDs illuminate at the same time, this may represent that the overall timing duration set by the user is 30 minutes, thereby allowing the user to be able to conveniently appreciate the overall timing duration currently configured therein. Furthermore, after that the user presses down the confirmation key 1142 to affirm and store the settings and exits the setup mode, all LEDs in the LED module 111 will be off so as to save electric power.

The cursor control key 1143 adopts the dual-axle/four-key design to control over the mouse cursor displayed on the application system 2 by the user. When the user needs the laser beam to point out the intended descriptions, the laser indictor key 1144 allows the user to generate an emission signal to the control unit 112 by pressing down the laser indictor key 1144, thereby letting the control unit 112 control the laser source module 117 to emit the laser beam.

The cancel key 1145 is used to simulate the escape key on the keyboard of the application system 2, and can set the overall timing duration in conjunction with the combined key group 1141 and the confirmation key 1142. The black screen control key 1146 is an auxiliary key for temporarily switching the contents of the presentation projection to the black screen upon being pressed down by the user.

Also, the accommodating space 118 in the operating main body 11 is further designed as a Push-Push typed slot, thereby enabling handy placement or access of the receiver 12 by the user.

Doubtlessly, the key arrangement and functions thereof in the operating module 114 according to the present embodiment, or even the display patterns of the LED module 111 in setting the overall timing duration, are all exemplary and illustrative, rather than be intended to limit the scope of the present invention thereto.

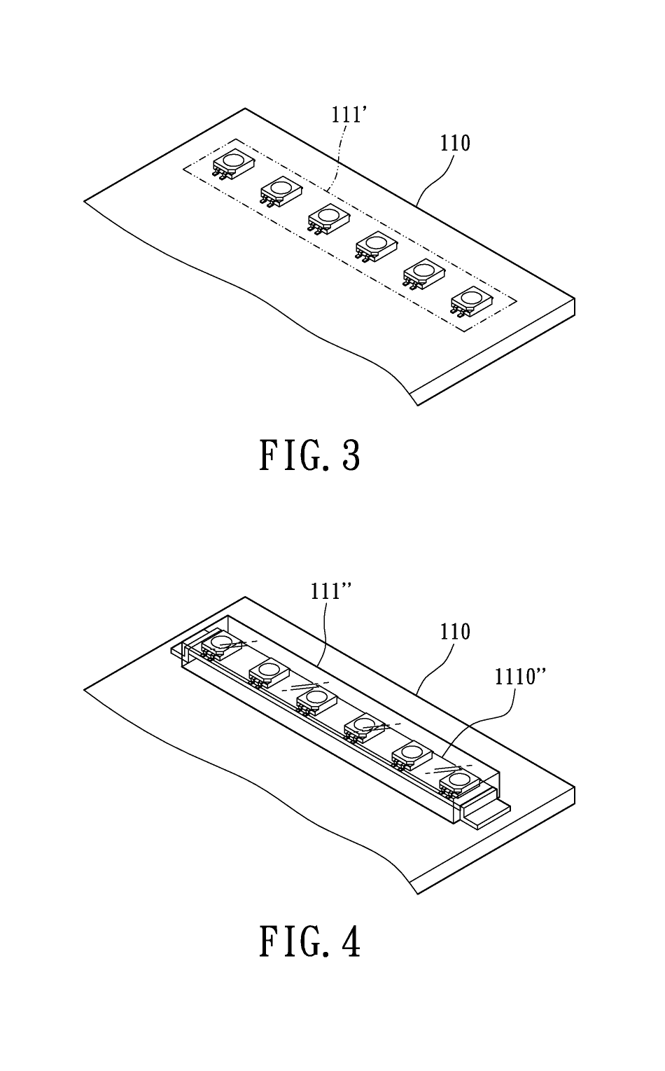

Refer next to FIG. 3 and FIG. 4, wherein diagrams for a first embodiment and a second embodiment of the LED module according to the present invention are respectively shown. Herein for the first embodiment in FIG. 3, a plurality of LEDs (e.g., 6) are directly soldered onto a printed circuit board (PCB) 110 in the operating main body 11 to form a LED module 111′. Although the LEDs used in the present embodiment adopt the design of Surface Mounted Device (SMD), other types such as Dual In-line Package (DIP) may be also applied without any limitations. Each of such LEDs respectively receives the control of the control unit 112 to perform operations like light ON/OFF or blinking in order to offer the timing message or the warning message as illustrated in the present invention. Besides, to acquire more variation effects in light sources, each LED may further adopt the design of multi-chip LED (e.g., RGB LED) thereby enabling control by the control unit 112 to generate colorful effects with multi-color mixtures and variations.

In terms of the LED arrangement, it is by no means limited to the straight-line style as shown in the present embodiment; other profiles, such as ring, star and so forth, can be also applied to increase visual effects thereof.

In the second embodiment of FIG. 4, an LED bar lamp is soldered onto the PCB 110 to form a LED module 111″. The architecture of the LED bar lamp is done by first using a carrier 1110″ to convey multiple LEDs and then having it packaged into a bar-type form. In this way, designer's burden in designing the layout of the PCB 110 may be reduced.

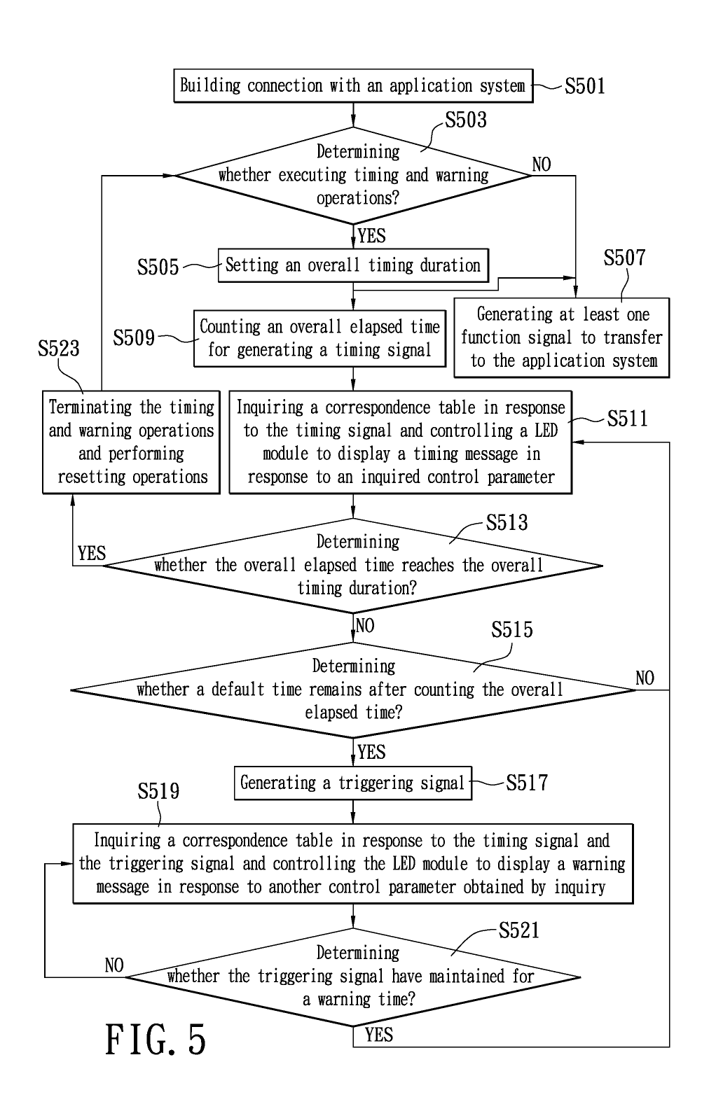

To facilitate better understanding of the control flow in operation of the presentation apparatus 1 according to the present invention, refer now to FIG. 5, wherein a flowchart for an embodiment of the control method to the presentation apparatus according to the present invention is shown. As illustrated in FIG. 5, the present embodiment provides a control method for the presentation apparatus according to the present invention, comprising the following steps: initially, establishing connections between the presentation apparatus and an application system (S501) to ensure effective signal transmissions between the presentation apparatus and an application system; next, determining whether performing a timing and warning operation (S503); if the determination in Step (S503) is positive, then setting an overall timing duration by the user (S505); after Step (S505), allowing the user to operate anytime the presentation apparatus to generate at least one function signal to transfer to the application system (S507); contrarily, suppose the determination in Step (S503) is negative, indicating that the user at present purely intends to operate the application system through the presentation apparatus, hence the process directly proceeds to Step (S507) in which a function signal will be generated and transferred to the application system.

Subsequently, as the user decides to start the presentation, controlling the counting an overall elapsed time up to the overall timing duration to generate a timing signal (S509), further inquiring a correspondence table based on the timing signal to control an LED module in the presentation apparatus to display a timing message in accordance with an inquired control parameter (S511). Herein the actual pattern of the displayed timing message may be for example first controlling all LEDs in the LED module to illuminate and then one LED may be turned off for each period of time (e.g., five minutes), thereby enabling illustration of the timing currently counted. Of course, the design approach may be reversed, that is controlling initially all LEDs in a state of light off, and then one LED is turned on every five minutes, so that the timing message can be analogously expressed. In brief, for those skilled person in the art, it can be understood that all effects of light source changes in LEDs can be used as the representation of the timing message for the present embodiment as long as they are well configured in factory beforehand.

Following this, determining whether the overall elapsed time reaches the overall timing duration (S513). If the determination in Step (S513) is no, indicating that the counting up to the overall timing duration continues, then further determining whether a default time remained as counting to the overall timing duration (S515); suppose the determination in Step (S515) is no, indicating the counted timing not yet reaching the default time, then the process returns to Step (S511) to continue the display of the timing message; contrarily, in case the determination in Step (S515) is yes, then generating a triggering signal (S517) and inquiring the correspondence table based on the timing signal and the triggering signal thereby controlling the LED module to display a warning message in accordance with another inquired control parameter (S519). The warning message may be similarly designed before factory shipment in order to emphasize the warning message through the effects of light source variations in LEDs (e.g., fast blinking or marquee twinkling displays in all LEDs).

Additionally, in an actual design, the default time mentioned in Step (S515) may be further configured as multiple default time points, and when any default time point is reached after counting the overall elapsed time up to the overall timing duration, a different triggering signal can be correspondingly generated so as to control the LED module to show a different warning message, thereby effectively prompting the user at different time point of default time.

Since, in the present embodiment, a common LED module is used to show the timing message and the warning message, the displayed warning message may not be shown all along, but rather simply sustains for a warning time; thus after Step (S519), it is required to further determine whether the triggering signal has maintained over the period of the warning time (S521). If the determination in Step (S521) is negative, indicating the duration of display time for the warning message not yet reaching the warning time, then repeating Steps (S519) and (S521) until the determination in Step (S521) altering to yes, subsequently stopping the generation of the triggering signal and re-executing Step (S511) and successive Steps thereafter.

Finally, in case the determination in Step (S513) is yes, meaning the counting to the overall timing duration is completely ended, thus terminating the counting and warning operations and executing an resetting operation (S523) in order to make the configured overall timing duration as well as other relevant counting actions reset (e.g. zero) for facilitating subsequent counting operations; after Step (S523), repeating Step (S503) and successive Steps thereafter. In this way, through repeating all of the aforementioned Steps, the control method for the presentation apparatus according to the present invention can be accomplished.

In summary, by means of the presentation apparatus and the control method thereof according to the presentation apparatus, the presentation apparatus itself no longer requires to additionally install other comparatively expensive components and modules (such as LCD); rather, it is possible use one single LED module in conjunction with the features of visual effect changes in light source generated, thereby allowing the user to clearly appreciate and well control the presentation time. As such, the presentation apparatus can achieve the objective for providing the advantages of both functionality and reduction in manufacturing cost.

However, the texts set forth as above are simply the detailed descriptions for the embodiments according to the present invention and the appended drawings thereof, rather than being used to limit the present invention thereto. The scope of the present invention should be delineated by the following claims, and all modifications, substitutions or alternations conveniently considered by those skilled ones in the art without departing from the field of the present invention are deemed as being included in the scope of the present invention defined by the claims illustrated hereunder.

What is claimed is:

1. A presentation apparatus, comprising:
an operating main body, further including:
a Light Emitting Diode (LED) module, including a plurality of LEDs and being disposed on a surface of the operating main body;
a control unit, electrically connected to the LED module; and
an operating module, electrically connected to the control unit for setting an overall timing duration, and being operated to generate at least one function signal of the presentation apparatus;
wherein the control unit controls the LED module to display a timing message in response to a timing signal, and in the existence of the timing signal, controls the LED module to display a warning message in accordance with a triggering signal; and
a receiver, wirelessly connected to the operating main body for receiving the function signal.

2. The presentation apparatus according to claim 1, wherein the LEDs are constructed as an LED bar lamp.

3. The presentation apparatus according to claim 1, wherein the operating main body further including:
a timing circuit, electrically connected to the control unit for counting an overall elapsed time to generate the timing signal, and generating the triggering signal upon at least a default time remained after counting the overall elapsed time, wherein the triggering signal maintains for a duration of warning time.

4. The presentation apparatus according to claim 3, wherein the control unit controls the counting circuit to start counting to the overall timing duration in response to an enable signal generated by a function key in the operating module.

5. The presentation apparatus according to claim 3, wherein the control unit controls the LEDs in the LED module based on the variation of the timing signal and the triggering signal to present different display patterns with respect to turning on or off different color lights or changing blinking frequency of the LEDs.

6. The presentation apparatus according to claim 5, wherein the LEDs present the display pattern of light ON/OFF according to one approach of a lighted marquee and lighting difference in arrangement.

7. The presentation apparatus according to claim 5, wherein the control unit further includes:
a storage unit, storing a correspondence table, in which the correspondence table records plural sets of control parameters to respectively represent the different display patterns presented by the LEDs;
whereby the control unit inquires the correspondence table based on the timing signal and the triggering signal so as to control the LEDs in the LED module in accordance with the inquired control parameter.

8. The presentation apparatus according to claim 7, wherein the control unit controls the LEDs to show a display pattern of simultaneously blinking three times as three minutes in the overall timing duration remained, and controls the LEDs to show a display pattern of simultaneously blinking and lasting for the duration of the warning time as one minute in the overall timing duration remained, thereby acting as the warning message.

9. The presentation apparatus according to claim 3, wherein the control unit further switches to operate in a setup mode and an operation mode based on a switch signal generated by a function key in the operating module.

10. The presentation apparatus according to claim 9, wherein, upon switching to the setup mode by the control unit, one combined key group in the operating module is used to set the overall timing duration, and each of the LEDs in the LED module indicates an accumulated time thereby displaying the overall timing duration in an accumulative sum.

11. The presentation apparatus according to claim 10, wherein, upon switching to the operation mode by the control unit, the combined key group is used to operate to generate a page turning function signal of the presentation apparatus.

12. The presentation apparatus according to claim 1, wherein the operating main body further includes:
a first radio frequency (RF) circuit, electrically connected to the control unit; and
a power supply unit, providing the power required for operations of the operating main body.

13. The presentation apparatus according to claim 12, wherein the control unit is electrically connected to the power supply unit, and upon detecting the voltage of the power supply unit being lower than a voltage threshold, controls the LED module to display a low power message.

14. The presentation apparatus according to claim 12, wherein the receiver is further connected to an application system for transferring the function signal generated by the operating main body to the application system.

15. The presentation apparatus according to claim 14, wherein the receiver further includes:
a system connector, electrically connected to the application system;
a second RF circuit, wirelessly connected to the first RF circuit in the operating main body; and
a microprocessor, electrically connected to the system connector and the second RF circuit thereby transforming the function signal generated by the operating main body and transferring the transformed function signal to the application system.

16. The presentation apparatus according to claim 1, wherein the operating main body further includes an accommodating space for accommodating the receiver.

17. The presentation apparatus according to claim 1, wherein the operating main body further include a laser source module electrically connected to the control unit for generating a laser beam.

18. A control method to a presentation apparatus, comprising the following steps of:
setting an overall timing duration, and counting an overall elapsed time up to the overall timing duration to generate a timing signal;
inquiring a correspondence table based on the timing signal to control an LED module to display a timing message in response to an inquired control parameter;
generating a triggering signal when counting the overall elapsed time remains a default time; and
inquiring the correspondence table based on the timing signal and the triggering signal to control the LED module to display a warning message in response to another inquired control parameter.

19. The control method according to claim 18, wherein when the triggering signal has been maintained over a period of a warning time, stopping the generation of the triggering signal and controlling the LED module to display the timing message according to the timing signal.

20. The control method according to claim 18, further comprising:
determining whether executing a timing and warning operation;
when the result of the determining step is negative, allowing operating to generate at least one function signal to transfer to the application system; and
when the result of the determining step is positive, setting the overall timing duration, and then allowing operating to generate the function signal to transfer to the application system.
